(19) United States
(12) Patent Application Publication
(10) Pub. No.: US 2012/0223796 A1
(43) Pub. Date: Sep. 6, 2012

(54) VARIABLE INDUCTOR

(76) Inventors: Kai-Yi Huang, Taipei City (TW); Yuh-Sheng Jean, Yun-Lin Hsien (TW); Ta-Hsun Yeh, Hsin-Chu City (TW)

(21) Appl. No.: 13/372,503

(22) Filed: Feb. 14, 2012

(30) Foreign Application Priority Data
Mar. 3, 2011 (TW) 100107092

(51) Int. Cl. H01F 29/02

(52) U.S. Cl. 336/142

(57) ABSTRACT

A variable inductor includes an inductor element and a first inductance adjusting circuit. The first inductance adjusting circuit includes a first open-loop structure and a first switch element. The first switch element is coupled to the first open-loop structure. When the first switch element is in a conducting state, the first open-loop structure and the first switch element forms a first closed-loop to induce a first magnetic flux which alters a magnetic flux from the inductor element in operation.

### BACKGROUND OF THE INVENTION

1. Field of the Invention

The present invention relates to a variable inductor, and more particularly, to a variable inductor utilizing eddy current effect to adjust its inductance.

2. Description of the Prior Art

In common semiconductor processes, a stacked spiral conductor structure or a spiral conductor structure on a plane is utilized to manufacture an inductor of desired inductance. Conventional semiconductor variable inductors are usually realized by spiral inductors with structural modification to achieve inductance adjustment. For example, please refer to FIG. 1 and FIG. 2. FIG. 1 is a circuit diagram of a conventional variable inductor 100, and FIG. 2 is an implementation structural diagram of the conventional variable inductor 100 shown in FIG. 1, wherein a first circuit 110 and a second circuit 120 are two circuits operating at different frequencies (e.g., the first circuit 110 and the second circuit 120 are for applications of two oscillating circuits at different frequencies of different wireless local network protocols). In FIG. 1 and FIG. 2, the conventional variable inductor 100 has four nodes NA1, NA2, NB1 and NB2, and one terminal (for example, a center tap) coupled to ground or to a fixed voltage level. When the system needs to be operated at a lower frequency, the variable inductor 100 will provide a higher inductance to the second circuit 120 via node NB1 and NB2; when the system needs to be operated at a higher frequency, the variable inductor 100 will provide a lower inductance to the first circuit 110 via node NA1 and NA2. As shown in FIG. 1 and FIG. 2, although the conventional inductor 100 can provide two different inductances, the structures are independent from each other and cannot be shared; furthermore, the structure must be matched to different corresponding application circuits. Therefore, the conventional variable inductor 100 still requires improvements with regards to manufacturing cost, parasitic effect, and power consumption.

Please refer to FIG. 3, which is an implementation structural diagram of another conventional variable inductor 300. The conventional variable inductor 300 shown in FIG. 3 is a stacked 3-dimensional structure comprising three parts: an inductor element LB1 on the upper part, an inductor element LB2 on the lower part, and a switch element SWT coupled between the inductor element LB1 and the inductor element LB2, wherein the two nodes P1, P2 of the conventional variable inductor 300 are located at a terminal of the inductor element LB1 and the inductor element LB2, respectively. When the switch element is in a conducting state, a circuit coupled between the nodes P1 and P2 will only see an inductance of the inductance element LB1; when the switch element is in a non-conducting state, the circuit coupled between the nodes P1 and P2 will see an inductance of the inductance element LB1 in series with the inductance element LB2. Therefore, the inductance of the conventional variable inductor 300 can be altered by an operation of the switch element SWT; however, the switch element SWT must be added onto the primary structure of the inductor. The parasitic capacitor and resistor thereof will influence an inductor quality of the variable conductor 300.

### SUMMARY OF THE INVENTION

In light of this, the present invention provides a variable inductor, wherein eddy current effect is utilized such that a typical inductor structure with a simple inductance adjusting circuit can easily achieve the goal of inductance adjustment; furthermore, the parasitic effect of the adjusting circuit in prior art can be efficiently suppressed.

According to an embodiment of the present invention, a variable inductor comprises an inductor element and a first inductance adjusting circuit. The first inductance adjusting circuit comprises a first open-loop structure and a first switch element. The first switch element is coupled to the first open-loop structure. When the first switch element is in a conducting state, the first open-loop structure and the first switch element forms a first closed-loop to induce a first magnetic flux which alters a magnetic flux from the inductor element in operation.

According to another embodiment of the present invention, a method of adjusting a variable inductor comprises: providing an inductor element; and utilizing eddy current effect to alter an inductance of the inductor element in operation.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a circuit diagram of a conventional variable inductor.

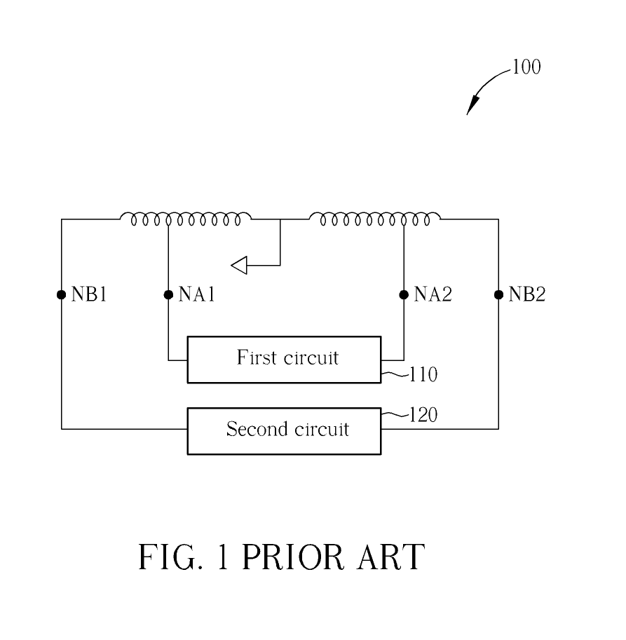

FIG. 2 is an implementation structural diagram of the conventional variable inductor shown in FIG. 1.

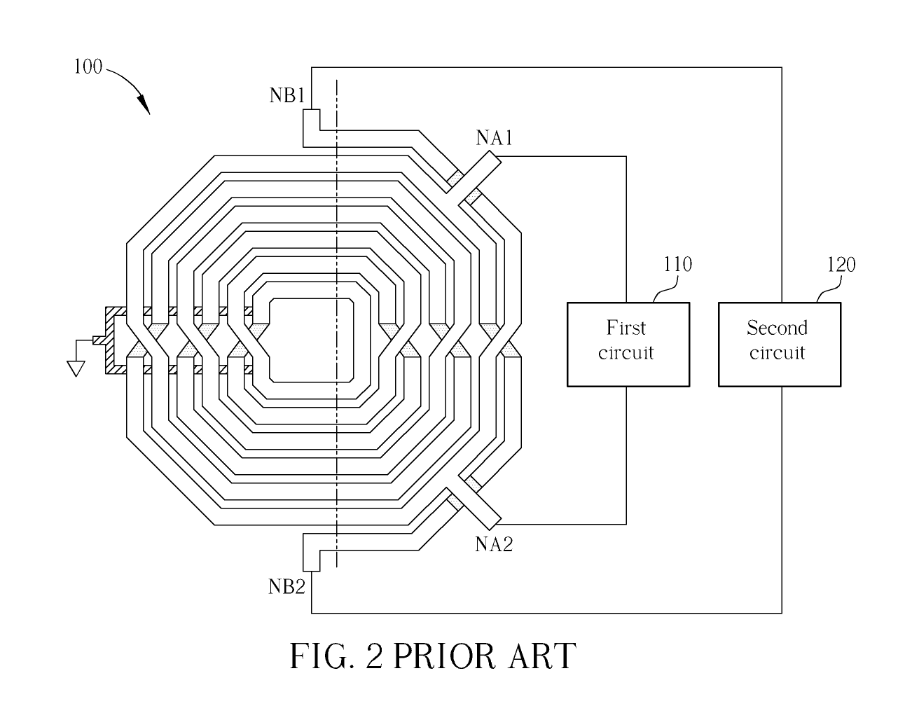

FIG. 3 is an implementation structural diagram of another conventional variable inductor.

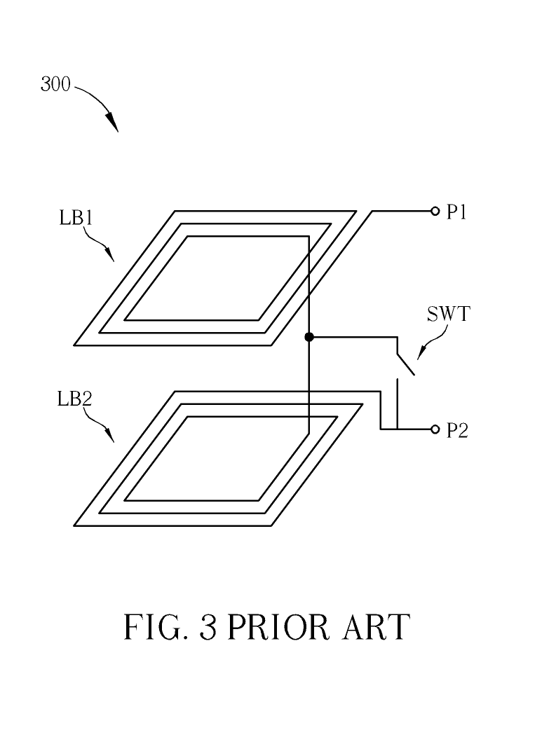

FIG. 4 is a structural diagram of a variable inductor according to an embodiment of the present invention.

FIG. 5 is a structural diagram of a variable inductor according to a second embodiment of the present invention.

FIG. 6 is a structural diagram of a variable inductor according to a third embodiment of the present invention.

FIG. 7 is a structural diagram of a variable inductor according to a fourth embodiment of the present invention.

### DETAILED DESCRIPTION

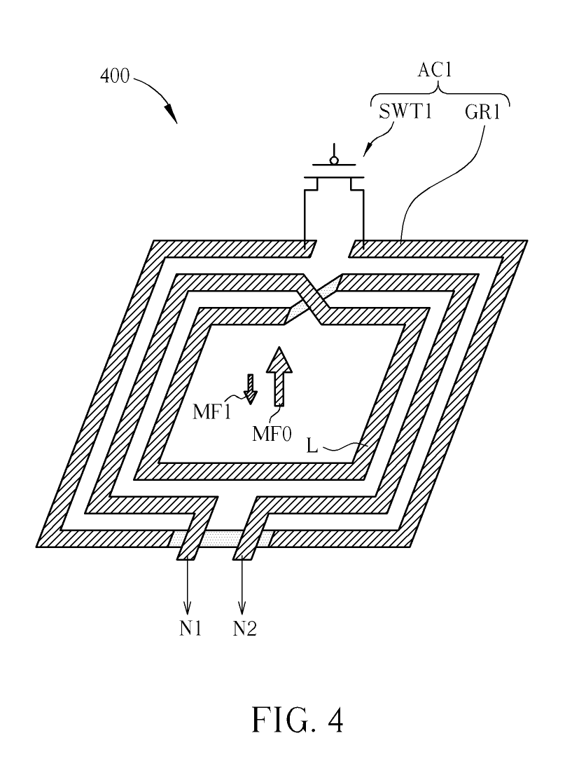

Please refer to FIG. 4, which is a structural diagram of a variable inductor 400 according to an embodiment of the present invention. The variable inductor 400, which may be implemented in an integrated circuit by semiconductor processes, includes an inductor element L and a first inductance adjusting circuit AC1. The inductor element L has two output nodes N1 and N2, and the first inductance adjusting circuit AC1 includes a first open-loop structure GR1 and a first switch element SWT1 (in this embodiment, the first switch element SWT1 is implemented by a transistor but this is for illustrative purpose only, and is not supposed to be a limitation of the present invention) . When the inductor element L is in operation and the first switch element SWT1 is in a non-conducting state, a current conducting in the inductor element L will generate a magnetic flux MF0 in the inductor element L. An inductance resulting from the magnetic flux MF0 can be observed at the output nodes N1 and N2; however, when the first switch element SWT1 is in a conducting state, the first open-loop structure GR1 and the first switch element SWT1 form a first closed-loop. Since the magnetic flux MF0 of the inductor element L in operation alters according to the current in the inductance element L, the eddy current effect will conduct a current in the first closed-loop formed by the first open-loop structure GR1 and the first switch element SWT1, and thereby generate a first magnetic flux MF1 to resist the variation of the magnetic flux MF0. As a result, the inductance observed at the output nodes N1 and N2 is altered.

In this embodiment, the first open-loop structure GR1 is a guard ring in peripherals of the inductor element L, and the two terminals of the first open-loop structure GR1 are connected via the first switch element SWT1. In other words, compared with the conventional variable inductor structure, the present invention only requires adjusting the guard ring in peripherals of the inductor element L to achieve the design of the first inductance adjusting circuit AC1. And the guard ring can also serve to prevent noise from the inductor element to other circuits or vice versa. No additional circuits are required, and therefore the variable inductor is easily accomplished and capable of being exploited in all kinds of differential circuit designs. In this embodiment, the inductor element L can be a spiral inductor realized by one single metal layer or a plurality of metal layers.

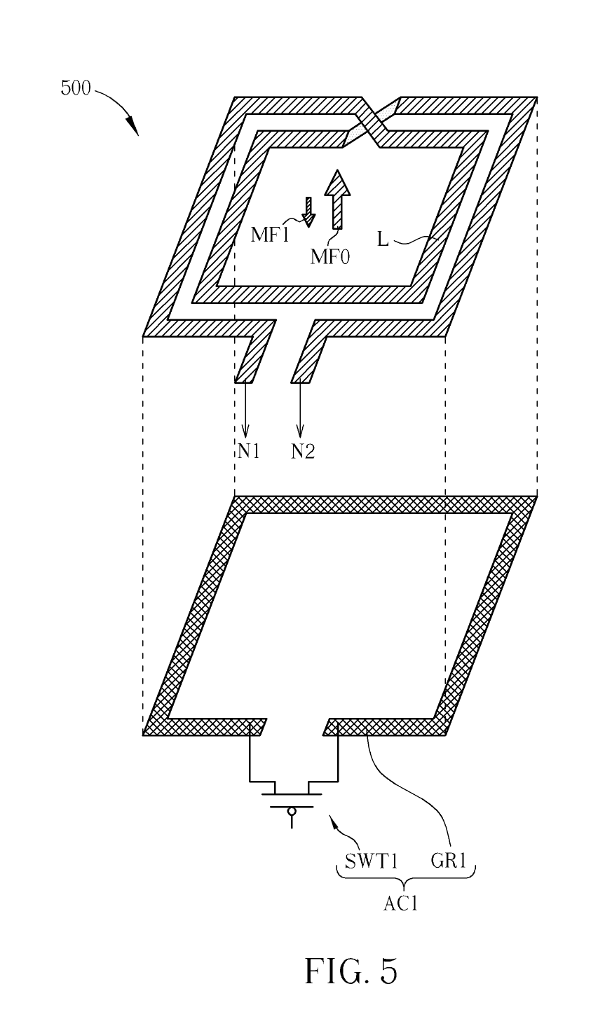

The structure above is only a preferred embodiment of the present invention; in other embodiments, the inductance adjusting circuit can also be implemented with other structures. For example, please refer to FIG. 5, which is a structural diagram of a variable inductor 500 according to a second embodiment of the present invention. The functions of circuit elements shown in FIG. 5 are substantially identical to their counterparts in FIG. 4, and therefore further descriptions are omitted here. Compared with the variable inductor 400 shown in FIG. 4, the first inductance adjusting circuit AC1 in FIG. 5 is arranged under the inductor element L instead of in the peripherals; however, when the first switch element SWT1 is conducting, the magnetic flux MF0 generated by the inductor element L in FIG. 5 will also induce eddy current effect upon the first inductance adjusting circuit AC1. As a result, the goal of inductance adjustment can also be achieved.

Please note that the above-mentioned first open-loop structure GR1 can be implemented by a metal layer on one identical plane as well as by a plurality of metal layers. The location of the first open-loop structure GR1 is also not limited to be in an upper part, a lower part, an internal part or an external part of the inductor part L, as long as the first inductance adjusting circuit AC1 is influenced by the eddy current effect when the closed-loop is formed and generates the first magnetic flux MF1 to partially resist against the original magnetic flux MF0 of the inductance element L. These variations in design all fall within the scope of the present invention. In other words, in a layout of an integrated circuit, the location of the first open-loop structure GR1 is not limited to be in an upper part, a lower part, an internal part, an external part of the inductor part L or stacked with the inductor part L wholly or partially.

In the present invention, if the open-loop structure is constructed by a guard ring, the guard ring can be made of one single metal layer or a stacked guard ring made of a plurality of metal layers. The width of the guard ring can also be adjusted by design: the larger the width of the guard ring, the lower the parasitic resistance of the guard ring; and therefore the eddy current effect can be enhanced to derive a lower inductance.

The inductance can also be adjusted by altering a resistance of the switch element. If the switch element is implemented by a transistor, the resistance can be altered by adjusting a size of the transistor: the greater the size of the transistor, the smaller the resistance; and therefore the eddy current effect can be enhanced to derive a lower inductance.

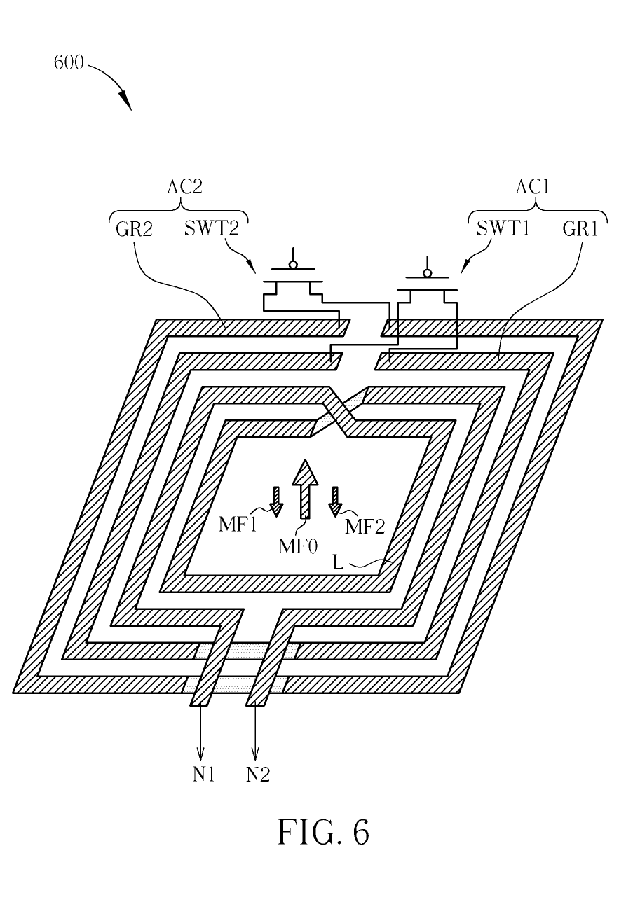

Please refer to FIG. 6, which is a structural diagram of a variable inductor 600 according to a third embodiment of the present invention. Compared with FIG. 4, an additional second inductance adjusting circuit AC2 is arranged in peripherals of the original first inductance adjusting circuit AC1. The second inductance adjusting circuit AC2 includes a second open-loop structure GR2 and a second switch element SWT2 (in this embodiment, the second switch element SWT2 is also implemented by a transistor but this is for illustrative purposes only, and is not supposed to be a limitation of the present invention). When the second switch element SWT2 is in a conducting state, the second open-loop structure GR2 and the second switch element SWT2 forms a second closed-loop. The eddy current effect will conduct a current in the second closed-loop formed by the second open-loop structure GR2 and the second switch element SWT2, and thereby generates a second magnetic flux MF2 to resist the variation of the magnetic flux MF0. Therefore, by operating the first switch element SWT1 and the second switch element SWT2 selectively, the variable inductor 600 is able to provide multiple different inductances. Please note that magnitudes of the first magnetic flux MF1 provided by the first inductance adjusting circuit AC1 and the second magnetic flux MF2 provided by the second inductance adjusting circuit AC2 are not necessarily identical and can be determined according to practical design requirements.

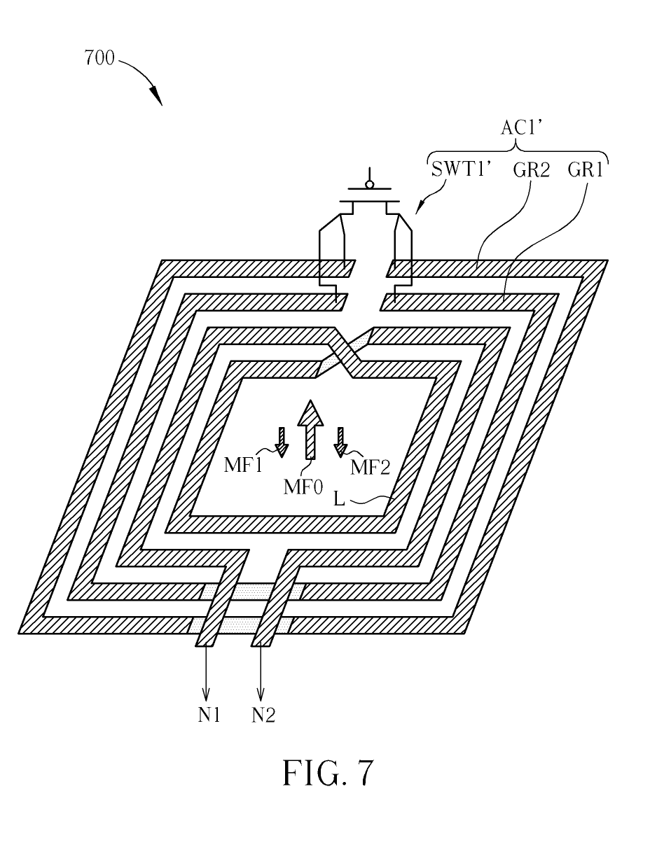

Please refer to FIG. 7, which is a structural diagram of a variable inductor 700 according to a fourth embodiment of the present invention. In contrast with the variable inductor 600 shown in FIG. 6, a first open-loop structure GR1 and a second open-loop structure GR2 of a first inductance adjusting circuit AC1′ of the variable inductor 700 shown in FIG. 7 are both coupled to an identical switch element SWT1′. When a first switch element SWT1′ is in a conducting state, the first open-loop structure GR1 and the first switch element SWT1′ form a first closed-loop to generate a first magnetic flux MF1 to resist the variation of the magnetic flux MF0. In addition, the second open-loop structure GR2 and the first switch element SWT1′ also form a second closed-loop simultaneously to generate a second magnetic flux MF2 to resist the variation of the magnetic flux MF0. This modification also falls within the scope of the present invention.

As demonstrated by the embodiments above, the present invention provides methods utilizing eddy current effect to alter an inductance of an inductor element in operation; for example, utilizing a conducting status of a switch (e.g., a transistor) and an open-loop structure (e.g., a guard ring) to control the eddy current effect thereof to alter the inductance. Such methods all coincide with the spirit of the present invention; however, the variable inductors of the present invention are not limited to utilizing two switch elements to control different inductances. Variable inductors utilizing multiple switch elements and one or more corresponding switch elements to control inductance thereof via eddy current effect all fall within the scope of the present invention.

To summarize, the present invention provides a variable inductor utilizing eddy current effect to achieve the goal of inductance adjustment. Different inductances can be easily derived by adding a simple adjusting circuit to a common inductor structure, and the spirit of the present invention can be easily applied to differential circuits without designing specific corresponding circuits.

Those skilled in the art will readily observe that numerous modifications and alterations of the device and method may be made while retaining the teachings of the invention.

What is claimed is:

1. A variable inductor, comprising:
an inductor element; and
a first inductance adjusting circuit, comprising:
a first open-loop structure; and
a first switch element, coupled to the first open-loop structure;
wherein when the first switch element is in a conducting state, the first open-loop structure and the first switch element forms a first closed-loop to induce a first magnetic flux which alters a magnetic flux from the inductor element in operation.

2. The variable inductor of claim 1, wherein the first switch element is a transistor.

3. The variable inductor of claim 1, wherein the first open-loop structure is a guard ring.

4. The variable inductor of claim 3, wherein the guard ring is a stacked guard ring.

5. The variable inductor of claim 1, wherein the first open-loop structure utilizes eddy current effect to generate the first magnetic flux to alter the magnetic flux from the inductor element in operation.

6. The variable inductor of claim 1, further comprising:
a second inductance adjusting circuit comprising:
a second open-loop structure; and
a second switch element, coupled to the second open-loop structure;
wherein when the second switch element is in a conducting state, the second open-loop structure and the second switch element forms a second closed-loop to induce a second magnetic flux which alters the magnetic flux from the inductor element in operation.

7. The variable inductor of claim 6, wherein the first and the second switch elements are both transistors, and the first and the second open-loop structures are both guard rings.

8. The variable inductor of claim 1, wherein the inductor is a spiral inductor.

9. The variable inductor of claim 8, wherein the spiral inductor is implemented with a plurality of metal layers.

10. The variable inductor of claim 1, wherein the first open-loop structure is arranged in peripherals of the inductor element.

11. The variable inductor of claim 1, wherein the first open-loop structure is arranged under the inductor element.

12. The variable inductor of claim 1, wherein the first inductance adjusting circuit further comprises a second open-loop structure; the first switch element is further coupled to the second open-loop structure; and when the first switch element is in the conducting state, the second open-loop structure and the first switch element forms a second closed-loop to induce a second magnetic flux which alters the magnetic flux from the inductor element in operation.

13. A method of adjusting a variable inductor, comprising:
providing an inductor element; and
utilizing eddy current effect to alter an inductance of the inductor element in operation.

14. The method of claim 13, wherein the eddy current effect is generated by utilizing a first open-loop structure and a first switch element coupled to the first open-loop structure, when the first switch element is in a conducting state, the first open-loop structure and the first switch element forms a first closed-loop to alter the inductance of the inductor element in operation.

15. The method of claim 14, wherein the first switch element is a transistor, and the first open-loop structure is a guard ring.
